(19) United States
(12) Patent Application Publication
(10) Pub. No.: US 2025/0392348 A1
(43) Pub. Date: Dec. 25, 2025

(54) REPEATER MODULE AND METHODS FOR A BUILDING NETWORK

(71) Applicant: Tyco Fire & Security GmbH, Neuhausen am Rheinfall (CH)

(72) Inventors: Datta Bhiva Padekar, Thane (IN); Sameer Kashinath Walwatkar, Mumbai (IN); Prajakta Sagun Bhike, Mumbai (IN); Chandrasai Balaramkrishna Rayudu, Mumbai (IN)

(73) Assignee: Tyco Fire & Security GmbH, Neuhausen am Rheinfall (CH)

(21) Appl. No.: 18/902,766

(22) Filed: Sep. 30, 2024

(30) Foreign Application Priority Data
Jun. 19, 2024 (IN) 202441047006

(51) Int. Cl. H04B 3/36; H04B 3/54; H04L 67/125

(52) U.S. Cl. CPC H04B 3/36; H04B 3/54; H04L 67/125

(57) ABSTRACT

An apparatus includes a repeater unit and a microcontroller unit (MCU) in communication with the repeater unit. The MCU is configured to control building equipment using signals communicated using a building equipment interface. The MCU is in communication with a network of controllers via a physical medium, and the repeater unit is configured to amplify signals on the physical medium.

### CROSS REFERENCE TO RELATED APPLICATIONS

This application claims the benefit of and priority to Indian Provisional Application No. 202441047006, filed Jun. 19, 2024, the entire disclosure of which is incorporated by reference herein.

### BACKGROUND

The present disclosure relates generally to building networks for monitoring and controlling building equipment in or around a building. More specifically, the present disclosure relates to systems and methods for communicating in a building network.

In a building, various pieces of building equipment (e.g., HVAC equipment, lighting equipment, security equipment, etc.) can communicate via a network within the building. The network may be a wired network, such a building automation and control network (BACnet) network. The network often includes a number of controllers. Connecting communication cable for a wired network through a building adds to the labor expense when installing building equipment. While laying out the network communication cables, a separate repeater is often installed either after every 32 to 50 system controllers or after a certain cable distance. The repeater is used to amplify the signals on the network such that the entire facility, building or network can communicate signals without losing signal strength required for effective communication.

### SUMMARY

Some embodiments relate to a building network system for a building including a controller and a repeater for the building.

Some embodiments relate to an apparatus including a repeater unit and a microcontroller unit (MCU) in communication with the repeater unit. The MCU is configured to control building equipment using signals communicated using a building equipment interface. The MCU is in communication with a network of controllers via a physical medium, and the repeater unit is configured to amplify signals on the physical medium.

In some embodiments, the MCU and the repeater unit are integrated together. In some embodiments, the MCU and the repeater unit are disposed on a single module. In some embodiments, the MCU is disposed in a first housing and the repeater unit is disposed in a second housing.

In some embodiments, the MCU and the repeater unit are mounted together and include a connection interface. In some embodiments, the MCU and the repeater unit receive power from a single power source. In some embodiments, the MCU and the repeater unit receive power from a same power source. In some embodiments, the MCU includes a universal serial bus interface.

Some embodiments relate to an apparatus including a repeater unit and a microcontroller unit (MCU) in communication with the repeater unit. The MCU is configured to control building equipment using signals communicated using a sensor actuator bus. The MCU is in communication with a network of controllers via a field controller bus. The repeater unit is configured to amplify signals on the field controller bus.

In some embodiments, the MCU and the repeater unit are integrated together. In some embodiments, the MCU and the repeater unit are disposed on a single module. In some embodiments, the MCU is disposed in a first housing and the repeater unit is disposed in a second housing. In some embodiments, the MCU and the repeater unit are mounted together and include a connection interface. In some embodiments, the MCU and the repeater unit receive power from a single power source. In some embodiments, the MCU and the repeater unit receive power from a same power source.

Some embodiments relate to a modular device. The modular device includes a repeater module and a microcontroller module (MCU) in communication with and attached to the repeater module. The MCU is configured to control building equipment using signals communicated using a building equipment interface, and the MCU is in communication with a network of controllers via a physical medium. The repeater module is configured to amplify signals on the physical medium.

In some embodiments, the physical medium is a cable. In some embodiments, the MCU and the repeater module are mounted together and include a connection interface. In some embodiments, the MCU is connected to the repeater module via the connection interface when the repeater module is mounted to the MCU. In some embodiments, the MCU is configured to control building equipment using first data on the physical medium and sensor data from a sensor coupled to a sensor actuator bus.

Some embodiments relate to a method of communicating on a network using the apparatus or device described above.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building equipped with a HVAC system, according to an exemplary embodiment.

FIG. 2 is a schematic block diagram of a waterside system that may be used in conjunction with the building of FIG. 1, according to an exemplary embodiment.

FIG. 3 is a schematic block diagram of an airside system that may be used in conjunction with the building of FIG. 1, according to an exemplary embodiment.

FIG. 4 is a schematic block diagram of a network including controllers and a combination controller/repeater for use in the building of FIG. 1, according to an exemplary embodiment.

FIG. 5 is a top view schematic drawing of the combination controller/repeater illustrated in FIG. 3, according to an exemplary embodiment.

FIG. 6 is a block diagram of panel for use in the building of FIG. 1, according to an exemplary embodiment.

### DETAILED DESCRIPTION

### Overview

Referring generally to the FIGURES, an interface or repeater device is used by building equipment (e.g., building controllers) connected to one or more wired building networks to exchange data according to various exemplary embodiments. In many buildings, building equipment is connected together in addition to being connected to external networks that may provide centralized services when the building equipment is being installed, tested, or used. In some embodiments, a repeater is installed either after every 32 to 50 system controllers or after covering a certain cable distance. In some embodiments, one or more repeaters integrated with one or more building controllers are configured to amplify the network signal such that the entire facility is covered without losing the signal strength.

In some embodiments, systems and methods avoid cost and reduce time associated with installation and operation of separate, stand-alone repeaters. In some embodiments, the system and methods avoid requirements of having steady separate mountings for the controller and repeater and of ensuring that the communication wires are properly terminated. In some embodiments, an integrated controller repeater is a seamless replacement for stand-alone repeaters and simplifies some or all of physical wiring among the repeater, controller and network. In some embodiments, the controllers provide power to the repeaters. In some embodiments, the power is provided to the repeater without requiring an additional transformer to power the repeater.

In some embodiments, a combined or integrated controller and repeater reduces installation cost and reduces commissioning time because the combination device does not require separate mounting hardware and a separate power supply. In some embodiments, the combined device is compact. The controller can be a direct digital control (DDC) controller for a building management system (BMS). In some embodiments, a DDC controller is connected to a repeater module by a modular connector which reduces the installation complications and costs involved in providing a separate repeater device.

A building controller (e.g., a building automation controller or building management system (BMS) controller) may refer to a device or system responsible for managing and controlling various aspects of a building's operations. The controllers can be used in any type of building (e.g., commercial, industrial, homes, and large residential buildings) to optimize energy usage, enhance comfort, ensure safety, and streamline maintenance processes. Building controllers can be equipped with various sensors to monitor environmental conditions such as temperature, humidity, occupancy, light levels, air quality, and more. These sensors provide real-time data to the controller and allow the controller to make informed decisions regarding building operations. The building controllers can control actuators such as HVAC equipment, lighting fixtures, security systems, and access controls. The controllers send signals to actuators to adjust settings based on the data collected from sensors and programmed parameters in some embodiments. The building controllers can utilize control algorithms to analyze sensor data and make decisions on how to adjust building systems for optimal performance. These algorithms can be pre-programmed or adaptive and learn from historical data to continuously improve efficiency and comfort in some embodiments.

A repeater unit or repeater may refer to a networking device in some embodiments. The networking device may be used to extend the range of a network by regenerating and retransmitting signals. The repeater can operate at the physical layer of the OSI (Open Systems Interconnection) model, which is the lowest layer responsible for transmitting raw data bits over a communication channel. The repeater can be configured to amplify weak signals. As data travels along a network cable, the signal tends to lose strength over distance due to attenuation (signal weakening). The repeater receives the weakened signal, boosts its power, and retransmits it at its original strength, effectively extending the reach of the network in some embodiments. In some embodiments, the repeater operates transparently, without modifying the data passing through it. The repeater can have limited functionality or be configured with features that address network congestion, collisions, or packet routing.

### Building Management System and HVAC System

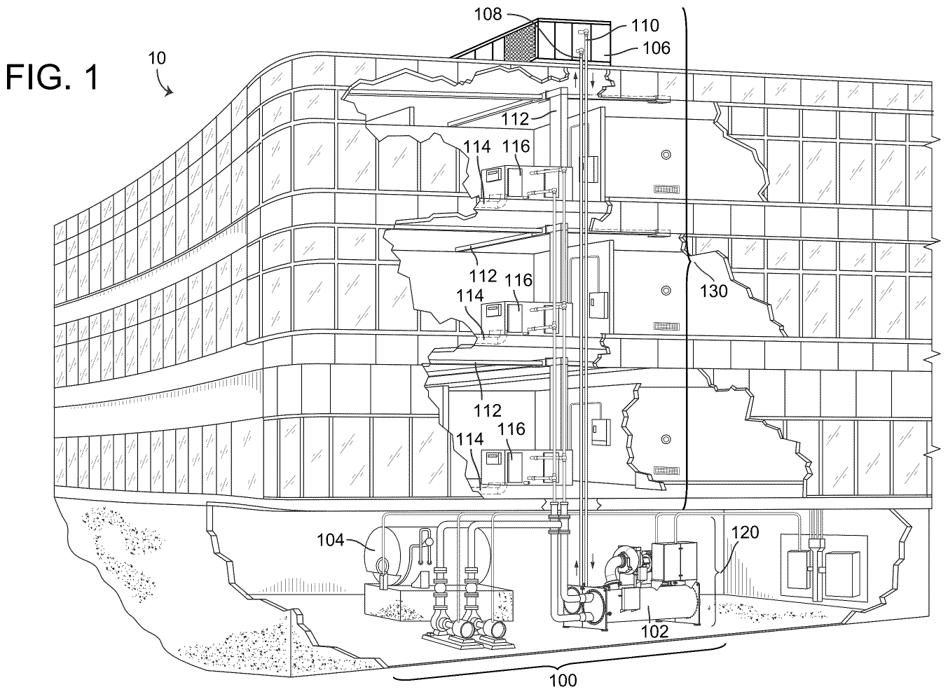

Referring now to FIGS. 1-3, an exemplary building management system (BMS) and HVAC system in which the systems and methods can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

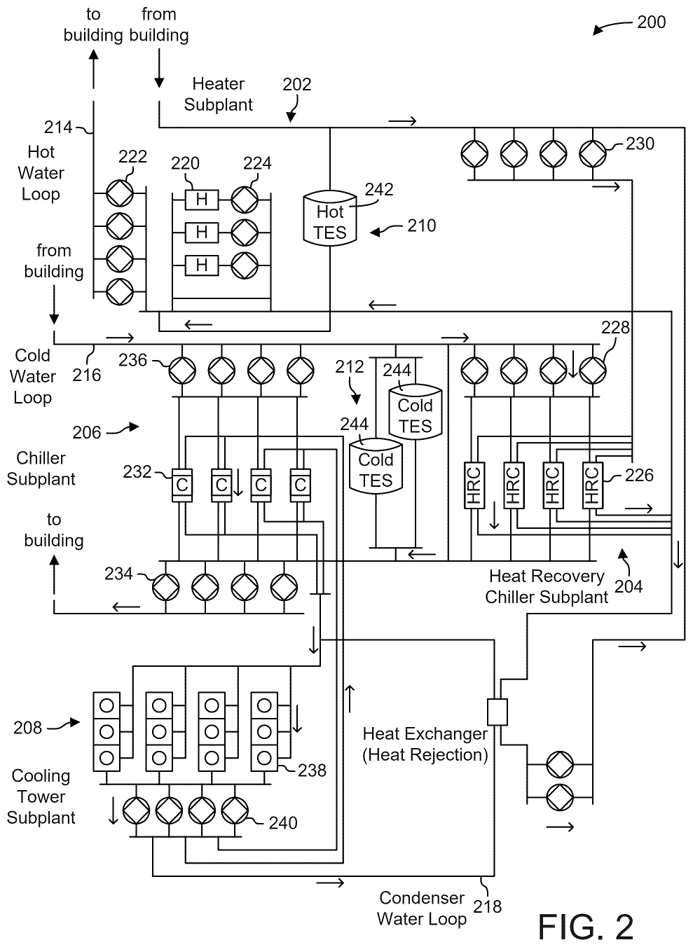

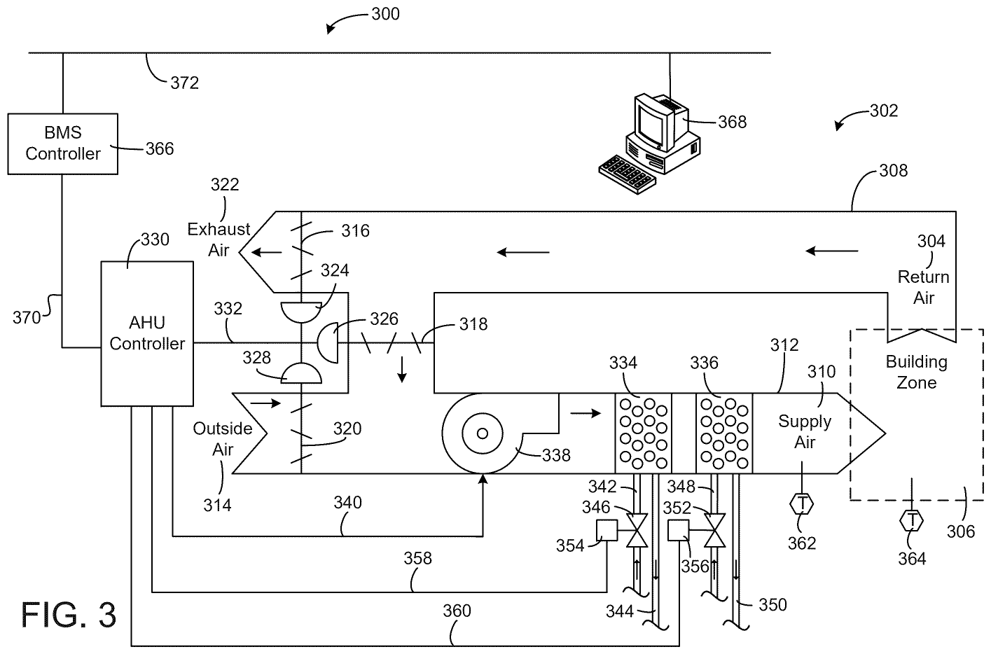

The BMS that serves building 10 includes an HVAC system 100. HVAC system 100 can include a plurality of HVAC devices (e.g., thermostats, sensors, controllers, heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366. A BMS controller 336 can utilized with any of the various building equipment described above. In some embodiments, controller 366 and/or controller 330 is integrated or provided with a repeater.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

### Building Wireless Network

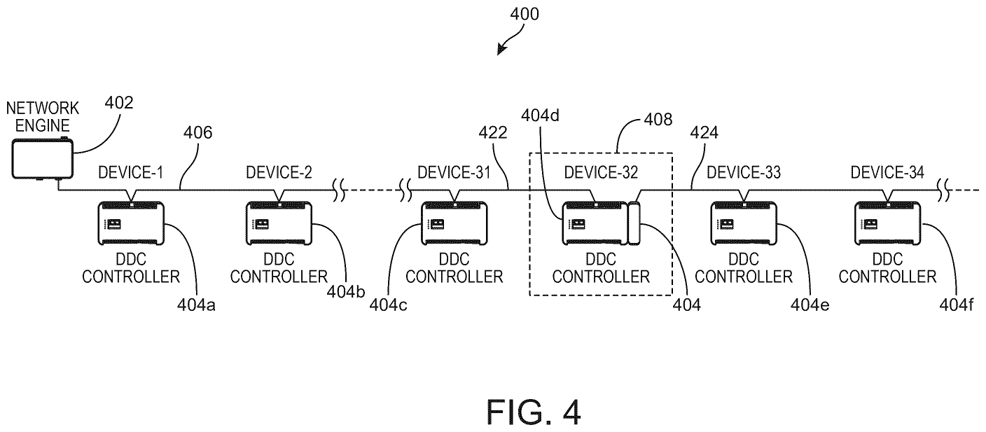

With reference to FIG. 4, a system 400 includes a network engine 402, a set of controllers 404A-F, and a cable 406. Controller 404D is part of a system 408 including controller 404D and a repeater 410. Any number of controllers 404A-F can be part of system 300. System 400 is part of a BMS (e.g., in building 10 of FIG. 1) in some embodiments. Controllers 404A-F can be similar to controllers 330 and 336 (FIG. 3). In some embodiments, network engine 402 is a device that manages communication and data transfer across the network associated with cable 406.

Cable 406 is a physical medium for system 400 configured as a wired network. Cable 406 can by a copper cable, coaxial cable, twisted pair cable, fiber optic cable, ethernet cable, a building automation network (BACNET) cable, etc. System 400 can be an Ethernet network, a BACNet, or other type network and can interface with wireless networks. The system 400 is a wired network (e.g., BACnet slave/token passing (MS/TP)) network) that provides connectivity across controllers 404A-F and building assets in some embodiments. The connectivity may include equipment-to-equipment connectivity, equipment-to-the cloud connectivity, mobile device to the cloud, and mobile devices-to-equipment in the building. Equipment-to-equipment connectivity may be necessary since during installation, equipment may need to communicate with each other to verify proper operation before network infrastructure of a building is in place. Equipment-to-the cloud connectivity may be necessary since equipment may need to be connected to the cloud to perform optimized service operations or other operations (e.g., remote configuration, remote status reporting, receiving remote control operations, cloud service testing, access diagnostic tools, device authentication for equipment to cloud operations, etc.).

In some embodiments, repeater 410 (e.g., a repeater module or unit) and controller 404D are coupled to each other and to cable 406 which is daisy chained or serially connected to controllers 404A-F. Controller 404D is coupled to an end or segment 422 of cable 406, and repeater 410 is coupled an end or segment 424 of cable 406. Segment 424 is coupled to controller 404E, and segment 422 is coupled to controller 404C.

Controllers 404A-F can be associated with any type of building equipment, such as the building equipment described above with to FIGS. 1-3. The building equipment can be sensors, motors, valves, dampers, fans, actuators, AHUs, RTUs, chillers, thermostats, network devices, security devices, cameras, interfaces, etc. Controllers 404A-F are DDC controllers or any device that communicates with and controls building systems. Controllers 404A-F can be configured to control equipment without the need for intermediate analog devices in some embodiments. DDC controllers can communicate directly and digitally to building equipment in a building automation systems (BAS) or building management systems (BMS) in some embodiments.

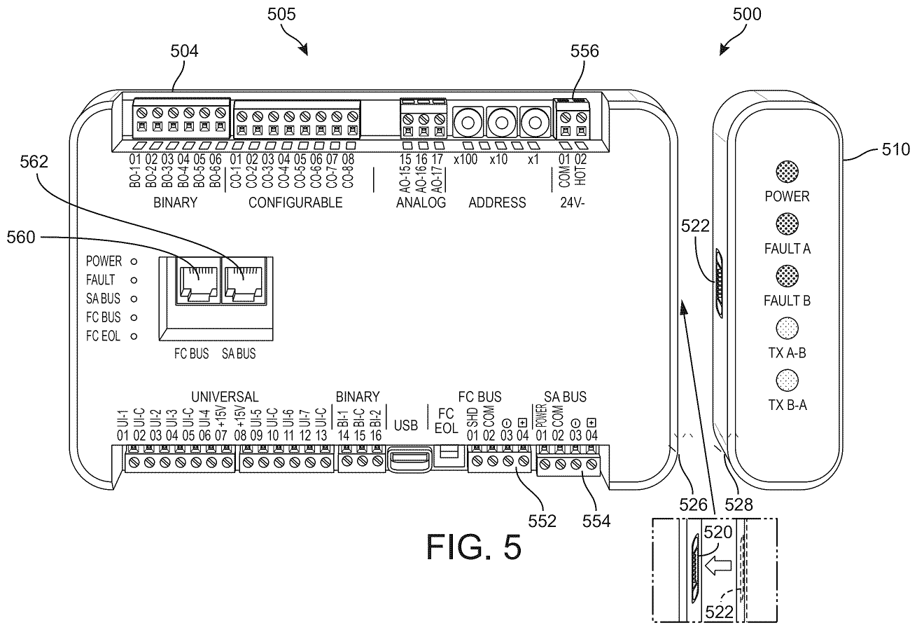

With reference to FIG. 5, a system 500 can be used as system 408 (e.g., a combined repeater/controller). System 500 includes a controller 504 (e.g., similar to controller 404D in FIG. 4) and a repeater 510 similar to repeater 410 in FIG. 4. Each of controller 504 and repeater 510 are disposed in their own modular housing. Repeater 510 is mounted on controller 504. Controller 504 includes a connector 520 and repeater 510 includes a connector 522. Connector 522 is connected to connector 520 when controller 504 is mounted to repeater 510 in some embodiments. In some embodiments, a bracket is provided for mounting both repeater 510 and controller 504. In some embodiments, a fastener is used to attach the housing of repeater 510 to controller 504. Connector 520 is disposed on a side 526 of controller 504, and connector 522 is disposed on a side 528 of repeater 510. Segments such as segments 422 and 424 (FIG. 4) are coupled to controller 504 in some embodiments.

Repeater 510 amplifies the signals on those segments through connections provided by connectors 520 and 522 or 560 and 562 in some embodiments. The segments can be coupled to an FC bus at connectors 554 and 552, respectively, or at connectors 564 and 562, respectively. Connectors 554 and 552 are Ethernet type connectors, and connectors 564 and 562 are general terminal connectors in some embodiments.

Power can be provided at a connector 556 for both repeater 510 and controller 504. The same power source can be used for both repeater 510 and controller 504, and power is provided from controller 504 to repeater 510 via connectors 520 and 522 in some embodiments. Controller 504 also includes a universal connector, a USB connector, a binary connector, a configurable interface, and an analog interface and can be connected to an SA bus. The controller 504 can control building equipment via the various interfaces 505 (e.g., one or more a building equipment interfaces).

In some embodiments, system 500 controls MS/TP devices on SA or FC bus. The SA bus and FC bus are used to facilitate communication between sensors, actuators, and controllers in industrial and building settings. Generally, the SA bus focuses on direct communication between sensors, actuators, and the central control system, and the FC bus enables distributed control and management of devices within specific field areas. The SA bus can be PROFIBUS, Modbus, or DeviceNet. Generally, the FC bus connects field controllers, which are devices responsible for coordinating and managing multiple sensors and actuators within a specific area or field. The FC bus can be part of a hierarchical control architecture, where field controllers interface with the central control system while managing local devices. The FC bus enables distributed control, allowing for autonomy and flexibility in managing processes or equipment at the field level in some embodiments. The FC bus can include a ControlNet, Foundation Fieldbus, MS/TP bus and PROFIBUS DP. Repeater 510 provides repeater operations for the FC bus (e.g., on cable 406) in some embodiments.

In some embodiments, controller 504 uses token passing algorithms. Interfaces of controller 504 can include a RS-485 serial port for communication with the wired network (e.g., a BACnet MS/TP network). Interfaces can be coupled with wired devices, such as HVAC devices, lighting devices, security devices, etc. In some embodiments, the wired network is coupled to building devices associated with a BMS.

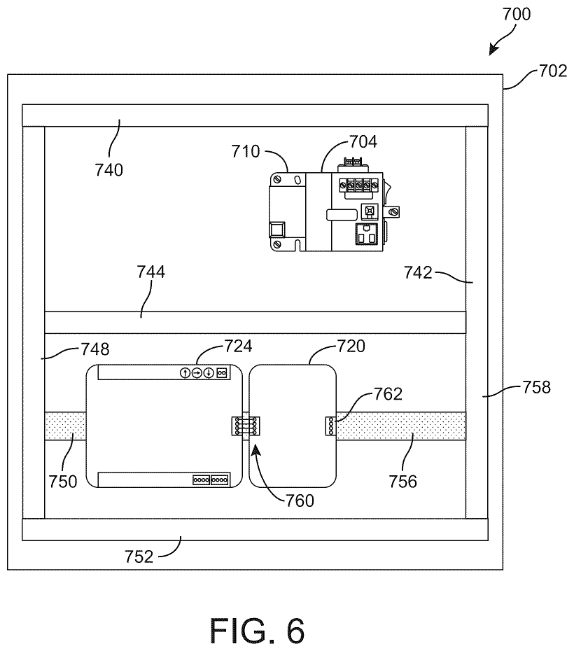

With reference to FIG. 6, a system 700 includes a panel 702. Panel 702 includes a controller 724 coupled with a repeater 720 by a connector interface 760, and a controller 704 integrated with a repeater 720. Controller 704 and repeater 710 are similar to controller 504 and repeater 510, and controller 724 and repeater 720 are similar to controller 504 and repeater 510. Panel 702 includes wire ducts 740, 750, 756,758, 752, and 748, and 744. Wire ducts 740, 744, 750, 756, 758, 752, and 748, and 744 provide a conduit for wires for the various connections to controllers 704 and 724 and repeaters 710 and 720. Controller 724 and repeater 720 are provided over ducts 750 and 756 and attach to wires in conduits or ducts 750 and 756 in some embodiments.

Controllers 404, 504, 704, and 724 and repeaters 410, 510, 710 and 720 can be a general purpose, communication, or specific purpose processor, an application specific integrated circuit (ASIC), one or more field programmable gate arrays (FPGAs), a group of processing components, or other suitable processing components. The processor may be configured to execute computer code and/or instructions stored in memory or received from other computer readable media (e.g., CDROM, network storage, a remote server, etc.). In some embodiments, the memory stores a Linux operating system, the Linux operating system can facilitate some and/or all of the functionality of the components of the memory. The memory can include one or more devices (e.g., memory units, memory devices, storage devices, etc.) for storing data and/or computer code for completing and/or facilitating the various processes described in the present disclosure. In some embodiments, the memory stores data and/or computer code for completing and/or facilitating the various processes relevant to the operation of communications. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures for controller 404.

Controllers 404, 504, 704, and 724 and repeaters 410, 510, 710 and 720 can use standards such as BAC net, IEEE 802.11 or any variation of IEEE 802.11 to implement networks. Controllers 404, 504, 704, and 724 and repeaters 410, 510, 710 and 720 may include sub-components which perform different functions, according to some embodiments.

Controllers 404, 504, 704, and 724 and repeaters 410, 510, 710 and 720 are possible according to various configuration and applications some embodiments. In some embodiments, for example, some or all of the controllers 404, 504, 704 may be environmental controller devices configured to transmit information between other environmental controller devices using and repeaters 410, 510, 710 and 720.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An apparatus, comprising:
a repeater unit; and
a microcontroller unit (MCU) in communication with the repeater unit, the MCU being configured to control building equipment using signals communicated using a building equipment interface, wherein the MCU is in communication with a network of controllers via a physical medium, wherein the repeater unit is configured to amplify signals on the physical medium.

2. The apparatus of claim 1, wherein the MCU and the repeater unit are integrated together.

3. The apparatus of claim 1, wherein the MCU and the repeater unit are disposed on a single module.

4. The apparatus of claim 1, wherein the MCU is disposed in a first housing and the repeater unit is disposed in a second housing.

5. The apparatus of claim 4, wherein the MCU and the repeater unit are mounted together and include a connection interface.

6. The apparatus of claim 1, wherein the MCU and the repeater unit receive power from a single power source.

7. The apparatus of claim 1, wherein the MCU and the repeater unit receive power from a same power source.

8. The apparatus of claim 1, wherein the MCU comprises a universal serial bus interface.

9. An apparatus, comprising:
a repeater unit; and
a microcontroller unit (MCU) in communication with the repeater unit, the MCU being configured to control building equipment using signals communicated using a sensor actuator bus, wherein the MCU is in communication with a network of controllers via a field controller bus, wherein the repeater unit is configured to amplify signals on the field controller bus.

10. The apparatus of claim 9, wherein the MCU and the repeater unit are integrated together.

11. The apparatus of claim 9, wherein the MCU and the repeater unit are disposed on a single module.

12. The apparatus of claim 9, wherein the MCU is disposed in a first housing and the repeater unit is disposed in a second housing.

13. The apparatus of claim 12, wherein the MCU and the repeater unit are mounted together and include a connection interface.

14. The apparatus of claim 1, wherein the MCU and the repeater unit receive power from a single power source.

15. The apparatus of claim 9, wherein the MCU and the repeater unit receive power from a same power source.

16. A modular device, comprising:
a repeater module; and
a microcontroller module (MCU) in communication with and attached to the repeater module, the MCU being configured to control building equipment using signals communicated using a building equipment interface, wherein the MCU is in communication with a network of controllers via a physical medium, wherein the repeater module is configured to amplify signals on the physical medium.

17. The device of claim 16, wherein the physical medium is a cable.

18. The device of claim 16, wherein the MCU and the repeater module are mounted together and include a connection interface.

19. The device of claim 18, wherein the MCU connected to the repeater module via the connection interface when the repeater module is mounted to the MCU.

20. The device of claim 16, wherein the MCU is configured to control building equipment using first data on the physical medium and sensor data from a sensor coupled to a sensor actuator bus.
